(19) United States
(12) Patent Application Publication
(10) Pub. No.: US 2025/0269935 A1
(43) Pub. Date: Aug. 28, 2025

(54) A HYDROFOIL ARRANGEMENT

(71) Applicant: Mantaray Hydrofoil Craft AB, Nacka Strand (SE)

(72) Inventor: Alexander SAHLIN, Huddinge (SE)

(73) Assignee: Mantaray Hydrofoil Craft AB, Nacka Strand (SE)

(21) Appl. No.: 18/858,451

(22) PCT Filed: Mar. 24, 2023
(86) PCT No.: PCT/SE2023/050267

§ 371 Date: Oct. 21, 2024

(30) Foreign Application Priority Data
Apr. 19, 2022 (SE) 2250467-4

(51) Int. Cl. B63B 1/24; B63B 1/28

(52) U.S. Cl. CPC B63B 1/242; B63B 1/283; B63B 1/285; B63B 2001/281

(57) ABSTRACT

A hydrofoil arrangement for a hydrofoil watercraft, comprising a base unit attachable to a body of the hydrofoil watercraft having a longitudinal extension extending in a longitudinal direction; a lifting wing; and first and second struts attached to the lifting wing and pivotally attached to the base unit so as to be rotatable in relation to the base unit. The lifting wing has a longitudinal extension. The first and second struts are configured to attach the lifting wing to the base unit such that the longitudinal extension of the lifting wing extends in the direction of a transverse axis transverse to the longitudinal direction. The struts and the lifting wing are rotatable about a first pivot axis in relation to the base unit, the first pivot axis being transverse to the transverse axis and the longitudinal direction. The struts are configured to rotate about the transverse axis in relation to the base unit while the struts and the lifting wing rotate about the first pivot axis.

### TECHNICAL FIELD

Aspects of the present invention relate to hydrofoil arrangement for a hydrofoil watercraft. Further, aspects of the present invention relate to a hydrofoil watercraft comprising such a hydrofoil arrangement.

### BACKGROUND

In general, a hydrofoil watercraft is a watercraft provided with one or more lifting wings which may be fully submerged below the surface of the water. In general, when a hydrofoil watercraft gains speed, the lifting wing lifts the hull of the watercraft out of the water, decreasing drag and allowing higher speed. Further, as a result, energy used for the propulsion, such as fuel or electric power, may be saved.

### SUMMARY

The inventor of the present invention has found drawbacks in conventional solutions for a hydrofoil arrangement of a hydrofoil watercraft. For example, the inventor of the present invention has found that some conventional solutions have a too complex structure or design. For example, the inventor of the present invention has found that some conventional solutions do not provide a sufficient stability for the hydrofoil watercraft in the water, for example upon or in roll.

An object of the invention is to provide a solution which mitigates or solves the drawbacks and problems of conventional solutions.

The above and further objects are solved by the subject matter of the independent claim. Further advantageous embodiments of the invention can be found in the dependent claims.

According to a first aspect of the invention, the above mentioned and other objects are achieved with a hydrofoil arrangement for a hydrofoil watercraft, wherein the hydrofoil arrangement comprises
one or more base units attachable to a body of the hydrofoil watercraft having a longitudinal extension extending in a longitudinal direction,
a lifting wing,
a first strut attached to the lifting wing, and
a second strut attached to the lifting wing,
wherein the first strut is pivotally attached to the base unit and is rotatable in relation to the base unit,
wherein the second strut is pivotally attached to the base unit and is rotatable in relation to the base unit,
wherein the lifting wing comprises a first end portion and a second end portion,
wherein the lifting wing has a longitudinal extension extending from the first end portion to the second end portion,
wherein the first and second struts are configured to attach the lifting wing to the base unit such that the longitudinal extension of the lifting wing extends in the direction of a transverse axis transverse to the longitudinal direction,
wherein the first and second struts and the lifting wing are rotatable about a first pivot axis in relation to the base unit, the first pivot axis being transverse to the transverse axis and the longitudinal direction, and
wherein the first and second struts are configured to rotate about the transverse axis in relation to the base unit while the first and second struts and the lifting wing rotate about the first pivot axis in relation to the base unit.

An advantage of the hydrofoil arrangement according to the first aspect is an improved stability for the hydrofoil watercraft in the water. An advantage of the hydrofoil arrangement according to the first aspect is an improved roll-stability of the hydrofoil watercraft in the water. An advantage of the hydrofoil arrangement according to the first aspect is that a less complex or complicated structure of the hydrofoil arrangement is provided, which, for example, is less sensitive to wear and more easily maintained in relation to conventional solutions. An advantage of the hydrofoil arrangement according to the first aspect is that the first and second struts do not have to be pivotally attached to the lifting wing in order to provide sufficient stability or roll-stability of the hydrofoil watercraft in the water. Instead, for some embodiments, the first and second struts may be fixedly or rigidly attached to the lifting wing, which results in a less complex structure of the hydrofoil arrangement, while still providing an improved or sufficient stability or roll-stability of the hydrofoil watercraft in the water. An advantage of the hydrofoil arrangement according to the first aspect is that the stability of the hydrofoil watercraft around the roll axis is improved. The roll axis may be substantially parallel to the longitudinal direction. An advantage of the hydrofoil arrangement according to the first aspect is that an improved hydrofoil watercraft is provided.

For some embodiments, it may be defined that the body of the hydrofoil watercraft comprises a hull. For some embodiments, the hydrofoil watercraft may be described as a hydrofoil watercraft having one or more fully submerged hydrofoils or lifting wings, i.e. one or more hydrofoils or lifting wings fully submerged below the surface of the water.

According to an advantageous embodiment of the hydrofoil arrangement according to the first aspect, when subjected to a lateral hydrodynamic force in the direction of the transverse axis, the first and second struts are configured to rotate about the transverse axis in relation to the base unit while the first and second struts and the lifting wing rotate about the first pivot axis in relation to the base unit. An advantage of this embodiment is that a further improved stability for the hydrofoil watercraft in the water is provided. An advantage of this embodiment is that a further improved roll-stability of the hydrofoil watercraft in the water is provided.

According to a further advantageous embodiment of the hydrofoil arrangement according to the first aspect, the first and second struts are configured to rotate about the transverse axis in relation to the base unit in opposite directions. An advantage of this embodiment is that a further improved stability for the hydrofoil watercraft in the water is provided. An advantage of this embodiment is that a further improved roll-stability of the hydrofoil watercraft in the water is provided. An advantage of this embodiment is that first and second struts, when rotating in opposite directions about the transverse axis, may force the lifting wing to twist about the transverse axis and thereby induce a modified lateral distribution of lift, which rolls the hydrofoil watercraft back to equilibrium after a lateral hydrodynamic force on the first and second struts.

According to another advantageous embodiment of the hydrofoil arrangement according to the first aspect, when the first and second struts rotate about the transverse axis in relation to the base unit, the longitudinal extension of the lifting wing is configured to twist about the transverse axis. An advantage of this embodiment is that a further improved stability for the hydrofoil watercraft in the water is provided. An advantage of this embodiment is that a further improved roll-stability of the hydrofoil watercraft in the water is provided.

According to yet another advantageous embodiment of the hydrofoil arrangement according to the first aspect, the first strut is movable in a direction in parallel to the transverse axis, and wherein the second strut is movable in a direction in parallel to the transverse axis. An advantage of this embodiment is that a further improved stability for the hydrofoil watercraft in the water is provided. An advantage of this embodiment is that a further improved roll-stability of the hydrofoil watercraft in the water is provided.

According to still another advantageous embodiment of the hydrofoil arrangement according to the first aspect, the first strut is fixedly attached to the lifting wing, and wherein the second strut is fixedly attached to the lifting wing. An advantage of this embodiment is that that an even less complex or complicated structure of the hydrofoil arrangement is provided. By having the strut fixedly attached to the lifting wing, a more robust structure is provided, which provides a lower hydrodynamic drag and is less complicated, and thus less expensive, to manufacture in relation to conventional solutions, for example in relation to conventional solutions having the strut pivotally attached to the lifting wing. A drawback of conventional solutions dependent on struts pivotally attached to the lifting wing is that an anhedral of the outer parts of a conventional lifting wing, that would have some advantages in hydrodynamic efficiency, may restrict an advantageous lateral movement of a conventional lifting wing for the roll-stability. However, by having the strut fixedly attached to the lifting wing in accordance with this embodiment, the lifting wing will be able to yaw together with the struts, such that an optional anhedral would not restrict the advantageous lateral movement of the hydrofoil watercraft.

According to an advantageous embodiment of the hydrofoil arrangement according to the first aspect, the hydrofoil watercraft is configured to travel in a forward direction, wherein when the base unit is attached to the body of the hydrofoil watercraft the first pivot axis is positioned in front of the centre of effort of the first strut and in front of the centre of effort of the second strut in the forward direction. An advantage of this embodiment is that the struts will be stable in pivotal displacement that will adjust itself corresponding to the yaw angle of the hydrofoil craft. An advantage of this embodiment is that a further improved roll-stability of the hydrofoil watercraft in the water is provided.

10 According to a further advantageous embodiment of the hydrofoil arrangement according to the first aspect, the first strut is rotatable about a second pivot axis in relation to the base unit,
wherein the second strut is rotatable about a third pivot axis in relation to the base unit.

An advantage of this embodiment is that a further improved stability for the hydrofoil watercraft in the water is provided. An advantage of this embodiment is that a further improved roll-stability of the hydrofoil watercraft in the water is provided.

According to another advantageous embodiment of the hydrofoil arrangement according to the first aspect, the second pivot axis is unparallel to the third pivot axis. An advantage of this embodiment is that the unparallelity between the second and third pivot axes induces a difference in angular displacement around the transverse axis between the first and second struts during a rotation around the first pivot axis. An advantage of this embodiment is that a further improved roll-stability of the hydrofoil watercraft in the water is provided.

According to yet another advantageous embodiment of the hydrofoil arrangement according to the first aspect, when subjected to a lateral hydrodynamic force in the direction of the transverse axis, the first and second struts are configured to rotate about the transverse axis in relation to the base unit while the first and second struts and the lifting wing rotate about the first pivot axis in relation to the base unit, while the first strut rotates about the second pivot axis in relation to the base unit, and while the second strut rotates about the third pivot axis in relation to the base unit. An advantage of this embodiment is that the lateral stabilisation of the hydrofoil watercraft does not require any servomotor, sensor or similar. An advantage of this embodiment is a less complex and less expensive hydrofoil arrangement in relation to conventional solutions.

According to still another advantageous embodiment of the hydrofoil arrangement according to the first aspect, the hydrofoil watercraft is configured to travel in a forward direction, wherein when the base unit is attached to the body of the hydrofoil watercraft the second and third pivot axes are positioned in front of the centre of effort of the first strut and in front of the centre of effort of the second strut in the forward direction. An advantage of this embodiment is that the struts will be stable in pivotal displacement that will adjust itself corresponding to the yaw angle of the hydrofoil craft.

According to an advantageous embodiment of the hydrofoil arrangement according to the first aspect, the hydrofoil arrangement comprises a first support arm attaching the first strut to the base unit,
wherein the hydrofoil arrangement comprises a second support arm attaching the second strut to the base unit,
wherein the first support arm is pivotally attached to the base unit and is rotatable in relation to the base unit, and
wherein the second support arm is pivotally attached to the base unit and is rotatable in relation to the base unit.

An advantage of this embodiment is that the first and second support arms transfer forces and moments between the struts and the base unit. For some embodiments, it may be defined that the first support arm is rotatable about the second pivot axis in relation to the base unit, and that the second support arm is rotatable about the third pivot axis in relation to the base unit.

According to a further advantageous embodiment of the hydrofoil arrangement according to the first aspect, when the base unit is attached to the body of the hydrofoil watercraft the second pivot axis crosses the third pivot axis on the level of or below one or more of the transverse axis and longitudinal extension of the lifting wing. An advantage of this embodiment is that the struts, while being rigidly attached to the lifting wing, can pivot without twisting, or twisting in a direction that enforces the roll-stabilisation. An advantage of this embodiment is that a further improved roll-stability of the hydrofoil watercraft in the water is provided.

According to still another advantageous embodiment of the hydrofoil arrangement according to the first aspect, the second pivot axis is transverse to the transverse axis and the longitudinal direction, wherein the third pivot axis is transverse to the transverse axis and the longitudinal direction. An advantage of this embodiment is that a further improved stability for the hydrofoil watercraft in the water is provided. An advantage of this embodiment is that a further improved roll-stability of the hydrofoil watercraft in the water is provided.

According to an advantageous embodiment of the hydrofoil arrangement according to the first aspect, the second pivot axis is unparallel to the transverse axis and the longitudinal direction, wherein the third pivot axis is unparallel to the transverse axis and the longitudinal direction. An advantage of this embodiment is that a further improved stability for the hydrofoil watercraft in the water is provided. An advantage of this embodiment is that a further improved roll-stability of the hydrofoil watercraft in the water is provided.

According to a further advantageous embodiment of the hydrofoil arrangement according to the first aspect, the first strut is rotatable about a fourth pivot axis in relation to the base unit,
wherein the second strut is rotatable about a fifth pivot axis in relation to the base unit.

An advantage of this embodiment is that a longitudinal separation between the second and third pivot axes relative the fourth and fifth pivot axes can yield a first pivot axis in front of the transversal axis. This gives the strut sufficient leverage around the first pivot axis without extreme longitudinal separation between the struts and the lifting wing.

According to another advantageous embodiment of the hydrofoil arrangement according to the first aspect, when the base unit is attached to the body of the hydrofoil watercraft the second pivot axis crosses the fourth pivot axis on the level of or below one or more of the transverse axis and longitudinal extension of the lifting wing while the third pivot axis crosses the fifth pivot axis on the level of or below one or more of the transverse axis and longitudinal extension of the lifting wing. An advantage of this embodiment is that with the crossings of the pivot axes below the lifting wing, the pivotal displacement of the struts can match the twisting of the lifting wing in a fast roll movement around the hydrofoil craft's centre of gravity. This allows for faster entering of a banked turn than for a hydrofoil craft with fixed struts.

According to yet another advantageous embodiment of the hydrofoil arrangement according to the first aspect, when subjected to a lateral hydrodynamic force in the direction of the transverse axis, the first and second struts are configured to rotate about the transverse axis in relation to the base unit while the first and second struts and the lifting wing rotate about the first pivot axis in relation to the base unit, while the first strut rotates about the second and fourth pivot axes in relation to the base unit, and while the second strut rotates about the third and fifth pivot axes in relation to the base unit. An advantage of this embodiment is that the lateral stabilisation of the hydrofoil watercraft does not require any servomotor, sensor or similar. An advantage of this embodiment is a less complex and less expensive hydrofoil arrangement in relation to conventional solutions.

According to still another advantageous embodiment of the hydrofoil arrangement according to the first aspect, the hydrofoil watercraft is configured to travel in a forward direction, wherein when the base unit is attached to the body of the hydrofoil watercraft
the second pivot axis is inclined upward to a port side of the hydrofoil watercraft in relation to the fourth pivot axis,
the third pivot axis is inclined upward to a starboard side of the hydrofoil watercraft in relation to the fifth pivot axis,
the second pivot axis is positioned in front of the fourth pivot axis in the forward direction, and
the third pivot axis is positioned in front of the fifth pivot axis in the forward direction.

An advantage of this embodiment is that the difference in inclination between the second and fourth pivot axes respective the third and fifth pivot axes induces a difference in angular displacement around the transverse axis between the first and second struts during a rotation around the first pivot axis. An advantage of this embodiment is that a further improved roll-stability of the hydrofoil watercraft in the water is provided.

According to an advantageous embodiment of the hydrofoil arrangement according to the first aspect, the hydrofoil watercraft is configured to travel in a forward direction, wherein when the base unit is attached to the body of the hydrofoil watercraft
the second pivot axis is inclined upward to a starboard side of the hydrofoil watercraft in relation to the fourth pivot axis,
the third pivot axis is inclined upward to a port side of the hydrofoil watercraft in relation to the fifth pivot axis,
the second pivot axis is positioned behind the fourth pivot axis in the forward direction, and
the third pivot axis is positioned behind the fifth pivot axis in the forward direction.

An advantage of this embodiment is that the difference in inclination between the second and fourth pivot axes respective the third and fifth pivot axes induces a difference in angular displacement around the transverse axis between the first and second struts during a rotation around the first pivot axis. An advantage of this embodiment is that a further improved roll-stability of the hydrofoil watercraft in the water is provided.

According to a further advantageous embodiment of the hydrofoil arrangement according to the first aspect, the hydrofoil arrangement comprises a first support arm attaching the first strut to the base unit,
wherein the hydrofoil arrangement comprises a second support arm attaching the second strut to the base unit,
wherein the first support arm is pivotally attached to the base unit and is rotatable about the second pivot axis in relation to the base unit,
wherein the second support arm is pivotally attached to the base unit and is rotatable about the third pivot axis in relation to the base unit,
wherein the first strut is rotatable about the fourth pivot axis in relation to the first support arm, and
wherein the second strut is rotatable about the fifth pivot axis in relation to the second support arm.

An advantage of this embodiment is that the first and second support arms can transfer necessary forces and moments from the struts to the base unit or base units. An advantage of this embodiment is that a further improved roll-stability of the hydrofoil watercraft in the water is provided.

According to another advantageous embodiment of the hydrofoil arrangement according to the first aspect, the hydrofoil arrangement comprises one or more first links pivotally connecting the first support arm to the second support arm. An advantage of this embodiment is that such a first link can keep the average angular displacement around the transverse axis of the first and second struts at a desired value. For embodiments of the hydrofoil arrangement according to the first aspect, comprising only the inclined second and third pivot axes, the advantage of such a first link is that the upper part of the struts can efficiently be kept parallel. An advantage of this embodiment is that a further improved roll-stability of the hydrofoil watercraft in the water is provided.

According to yet another advantageous embodiment of the hydrofoil arrangement according to the first aspect, the one or more first links comprises/comprise a first end portion and a second end portion,
wherein the one or more first links has/have a longitudinal extension extending from the first end portion to the second end portion of the one or more first links, and
wherein the one or more first links is/are adjustable so as to adjust the length of the longitudinal extension of the one or more first links.

An advantage of this embodiment is that an efficient control of the angle of incidence of the lifting wing is provided by way of the above-mentioned adjustability of the one or more first links.

According to still another advantageous embodiment of the hydrofoil arrangement according to the first aspect, the hydrofoil arrangement comprises one or more second links pivotally connecting the first strut to the base unit, wherein the hydrofoil arrangement comprises one or more third links pivotally connecting the second strut to the base unit. An advantage of this embodiment is that the upper parts of the struts can efficiently be kept parallel by the second and third links.

According to an advantageous embodiment of the hydrofoil arrangement according to the first aspect, the hydrofoil arrangement comprises one or more fourth links pivotally connecting the first strut to the second strut. An advantage of this embodiment is that the upper parts of the first and second struts can be efficiently kept parallel with only two links instead of three links, as for embodiments with the first, second and third links.

According to a further advantageous embodiment of the hydrofoil arrangement according to the first aspect, the transverse axis extends through the first and second end portions of the lifting wing. An advantage of this embodiment is that a further improved stability for the hydrofoil watercraft in the water is provided. An advantage of this embodiment is that a further improved roll-stability of the hydrofoil watercraft in the water is provided.

According to another advantageous embodiment of the hydrofoil arrangement according to the first aspect, the transverse axis extends from the attachment of the first strut to the lifting wing to the attachment of the second strut to the lifting wing. An advantage of this embodiment is that a further improved stability for the hydrofoil watercraft in the water is provided. An advantage of this embodiment is that a further improved roll-stability of the hydrofoil watercraft in the water is provided.

According to yet another advantageous embodiment of the hydrofoil arrangement according to the first aspect, the transverse axis extends through the longitudinal extension of the lifting wing. An advantage of this embodiment is that a further improved stability for the hydrofoil watercraft in the water is provided. An advantage of this embodiment is that a further improved roll-stability of the hydrofoil watercraft in the water is provided.

According to still another advantageous embodiment of the hydrofoil arrangement according to the first aspect, the first end portion of the lifting wing comprises a first end,
wherein the second end portion of the lifting wing comprises a second end,
wherein when the base unit is attached to the body of the hydrofoil watercraft the first end is angled downward in relation to one or more of the transverse axis and longitudinal extension of the lifting wing, and
wherein when the base unit is attached to the body of the hydrofoil watercraft the second end is angled downward in relation to one or more of the transverse axis and longitudinal extension of the lifting wing.

An advantage of this embodiment is that lower positions of the wingtips are obtained without making the struts longer, that allows for a higher banking angle in a turn. A further advantage of this embodiment is that the downward-angled wingtips get a longer leverage about the centre of gravity for increments in lift, that provides the roll stabilisation, further improving the roll-stability of the hydrofoil watercraft in the water.

According to a second aspect of the invention, the above mentioned and other objects are achieved with a hydrofoil watercraft having a longitudinal extension extending in a longitudinal direction, wherein the hydrofoil watercraft comprises a body and one or more hydrofoil arrangements according to any one of the embodiments disclosed above or below.

Advantages of the hydrofoil watercraft according to the second aspect correspond to the above- or below-mentioned advantages of the hydrofoil arrangement according to the first aspect and its embodiments.

For some embodiments, it may be defined that the body of the hydrofoil watercraft comprises a hull. For some embodiments, it may be defined that one or more of the hydrofoil arrangement and base unit is/are attached to the body of the hydrofoil watercraft. For some embodiments, the hydrofoil watercraft may be described as a hydrofoil watercraft having one or more fully submerged hydrofoils or lifting wings.

The above-mentioned features and embodiments of the hydrofoil arrangement and the hydrofoil watercraft, respectively, may be combined in various possible ways providing further advantageous embodiments.

Further advantageous embodiments of the hydrofoil arrangement and the hydrofoil watercraft according to the present invention and further advantages with the embodiments of the present invention emerge from the detailed description of embodiments.

### BRIEF DESCRIPTION OF THE DRAWINGS

Embodiments of the invention will now be illustrated, for exemplary purposes, in more detail by way of embodiments and with reference to the enclosed drawings, where similar references are used for similar parts, in which:

FIG. 1 is a schematic perspective view of an embodiment of the hydrofoil watercraft according to the second aspect of the invention provided with an embodiment of the hydrofoil arrangement according to the first aspect of the invention;

FIG. 2 is a schematic side view of the hydrofoil watercraft of FIG. 1;

FIG. 3 is a schematic cut-away top view of the hydrofoil watercraft of FIG. 1;

FIG. 4 is a schematic front view of the hydrofoil watercraft of FIG. 1 when subjected to a lateral hydrodynamic force;

FIG. 5 is a schematic side view of the hydrofoil watercraft of FIG. 1 when subjected to a lateral hydrodynamic force;

FIG. 6 is a schematic perspective front view of a first embodiment of the hydrofoil arrangement according to the first aspect of the invention;

FIG. 7 is a schematic front view of the hydrofoil arrangement of FIG. 6;

FIG. 8 is a schematic side view of the hydrofoil arrangement of FIG. 6; FIG. 9 is a schematic perspective rear view of the hydrofoil arrangement of FIG. 6;

FIG. 10 is a schematic rear view of the hydrofoil arrangement of FIG. 6;

FIG. 11 is a schematic top view of the hydrofoil arrangement of FIG. 6;

FIG. 12 is a schematic front view of the hydrofoil arrangement of FIG. 6 when subjected to a lateral hydrodynamic force;

FIG. 13 is a schematic top view of the hydrofoil arrangement of FIG. 6 when subjected to a lateral hydrodynamic force;

FIG. 14 is a schematic side view of the hydrofoil arrangement of FIG. 6 when subjected to a lateral hydrodynamic force;

FIG. 15 is a schematic front view of a second embodiment of the hydrofoil arrangement according to the first aspect of the invention;

FIG. 16 is a schematic perspective front view of a third embodiment of the hydrofoil arrangement according to the first aspect of the invention;

FIG. 17 is a schematic front view of the hydrofoil arrangement of FIG. 16;

FIG. 18 is a schematic side view of the hydrofoil arrangement of FIG. 16;

FIG. 19 is a schematic top view of the hydrofoil arrangement of FIG. 16;

FIG. 20 is a schematic front view of the hydrofoil arrangement of FIG. 16 when subjected to a lateral hydrodynamic force;

FIG. 21 is a schematic side view of the hydrofoil arrangement of FIG. 16 when subjected to a lateral hydrodynamic force;

FIG. 22 is a schematic perspective front view of a fourth embodiment of the hydrofoil arrangement according to the first aspect of the invention;

FIG. 23 is a schematic front view of the hydrofoil arrangement of FIG. 22;

FIG. 24 is a schematic side view of the hydrofoil arrangement of FIG. 22;

FIG. 25 is a schematic top view of the hydrofoil arrangement of FIG. 22;

FIG. 26 is a schematic front view of the hydrofoil arrangement of FIG. 22 when subjected to a lateral hydrodynamic force;

FIG. 27 is a schematic top view of the hydrofoil arrangement of FIG. 22 when subjected to a lateral hydrodynamic force; and

FIG. 28 is a schematic side view of the hydrofoil arrangement of FIG. 22 when subjected to a lateral hydrodynamic force.

### DETAILED DESCRIPTION

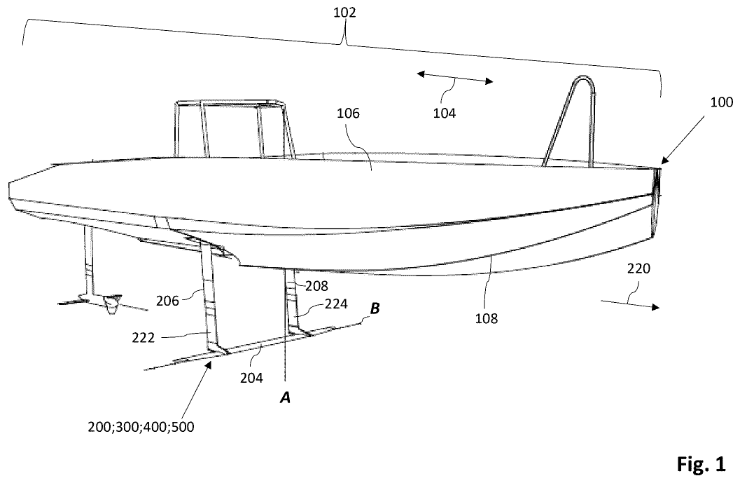

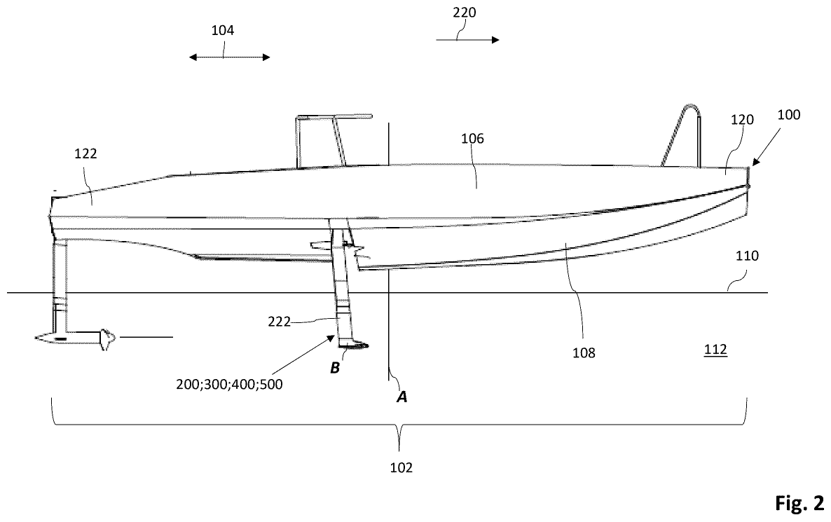

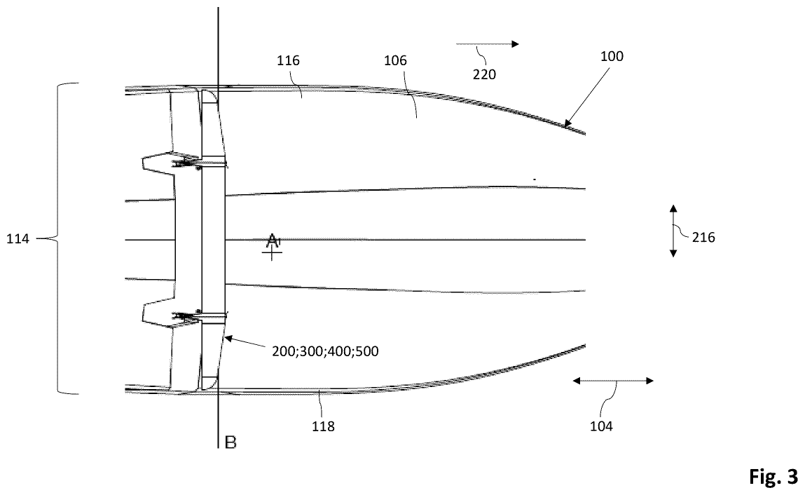

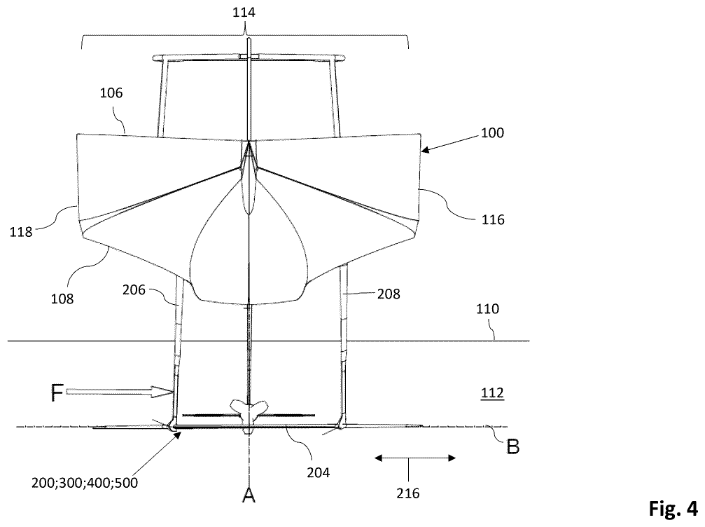

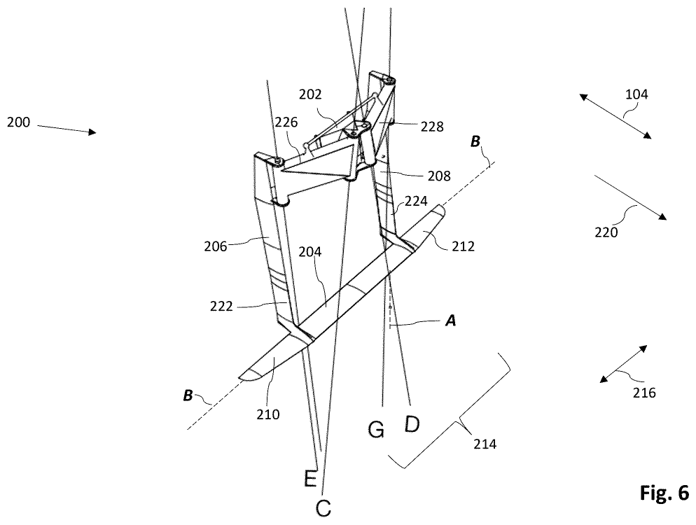

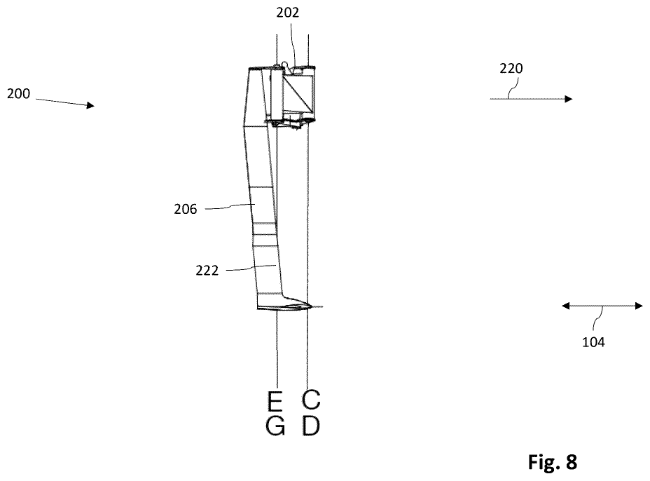

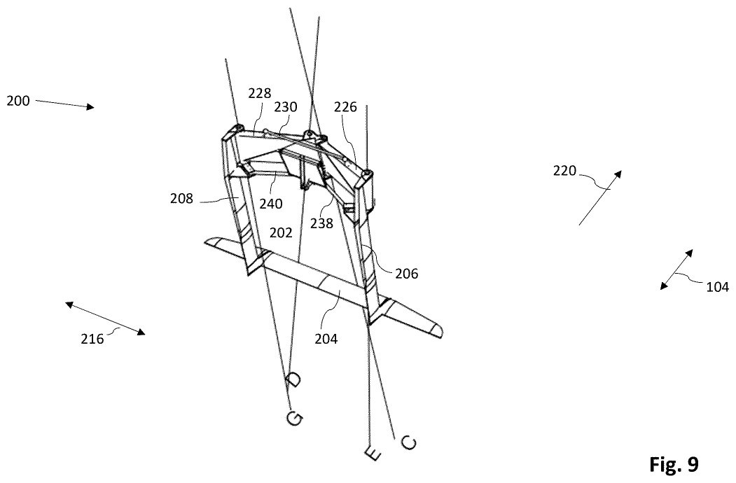

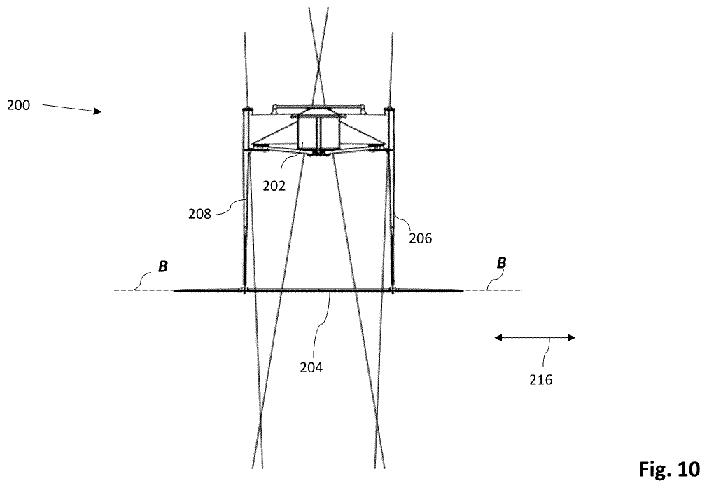

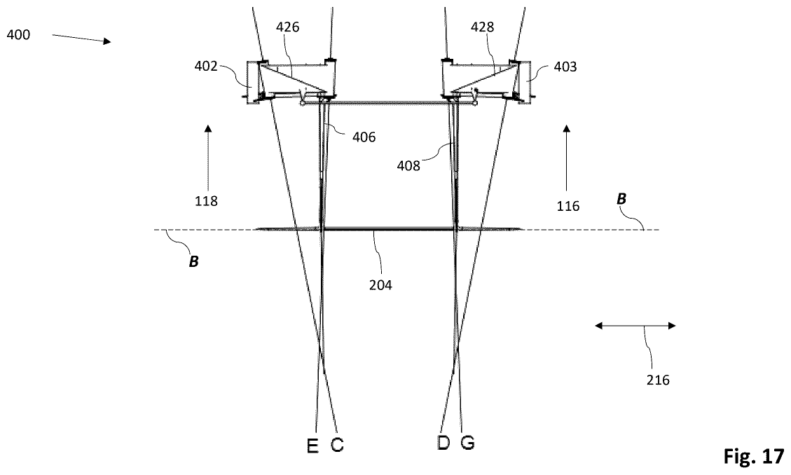

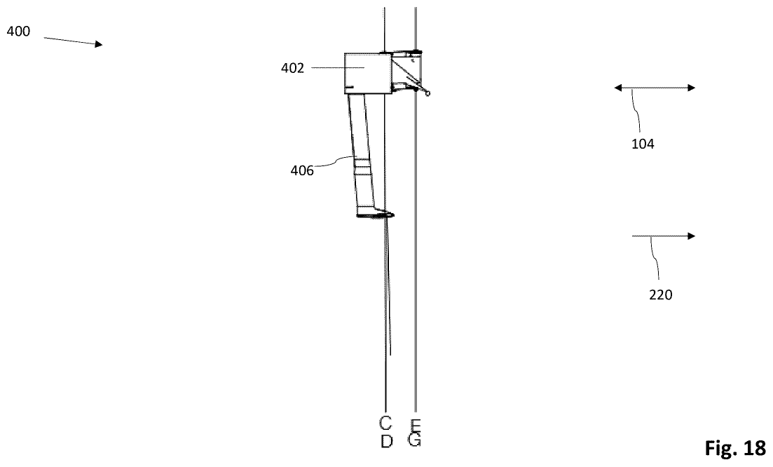

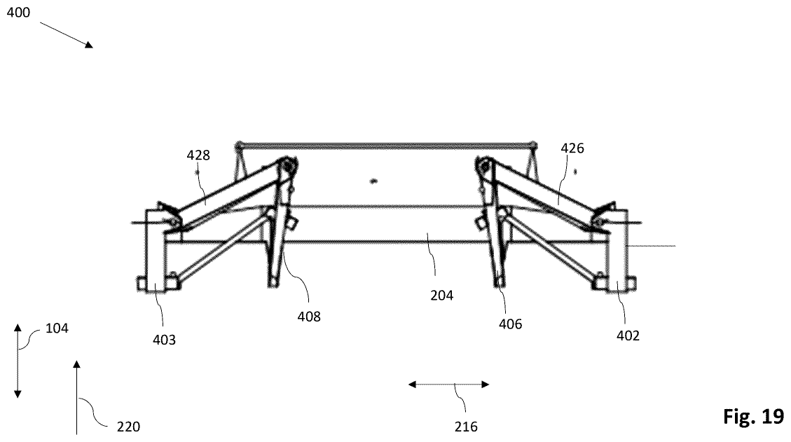

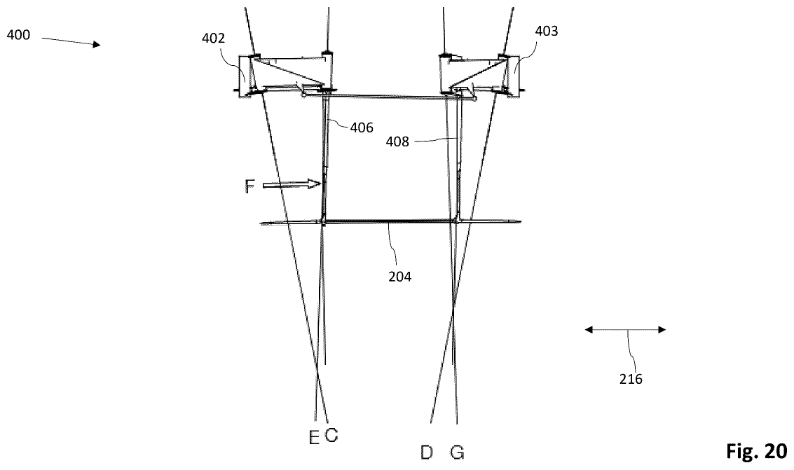

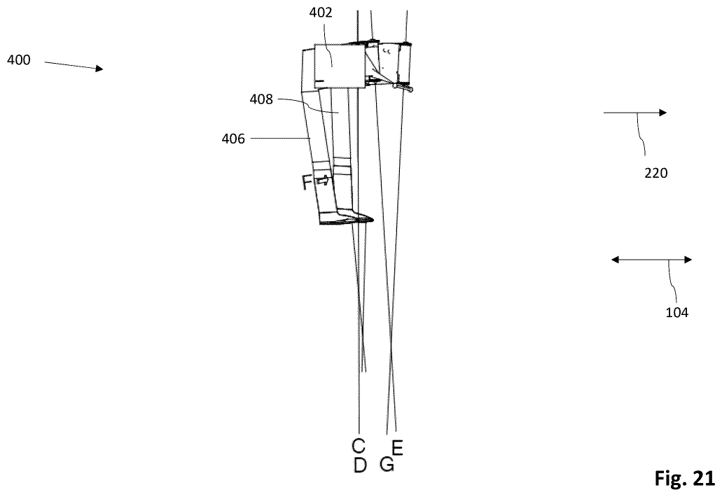

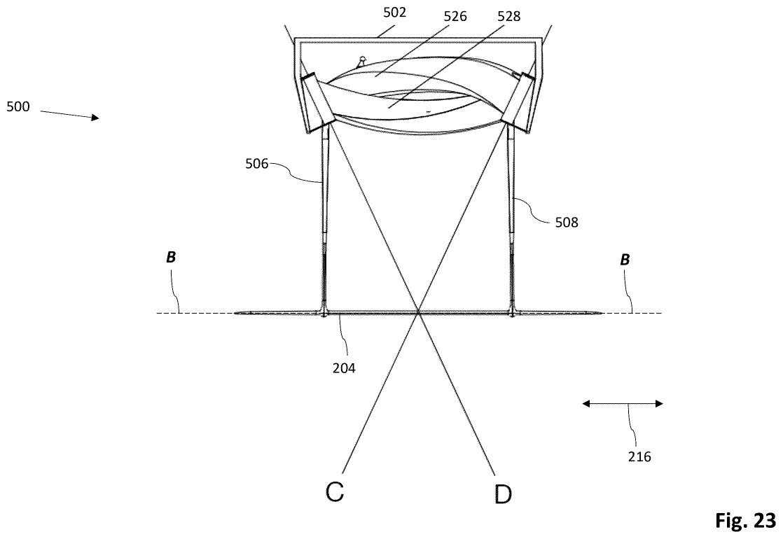

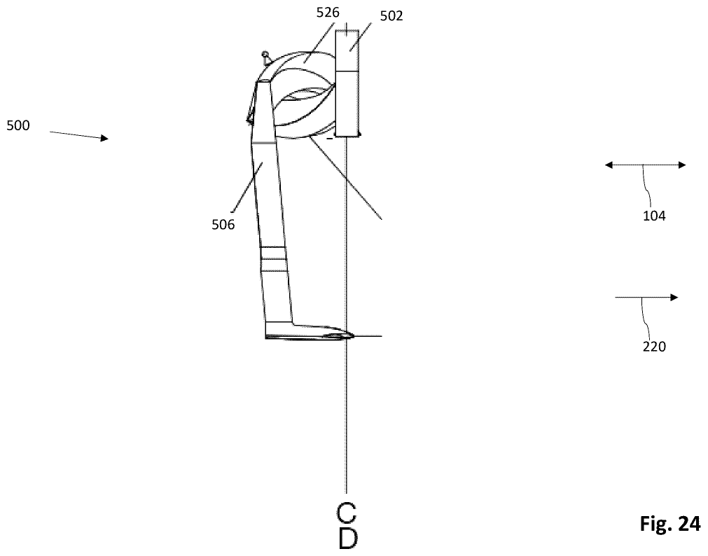

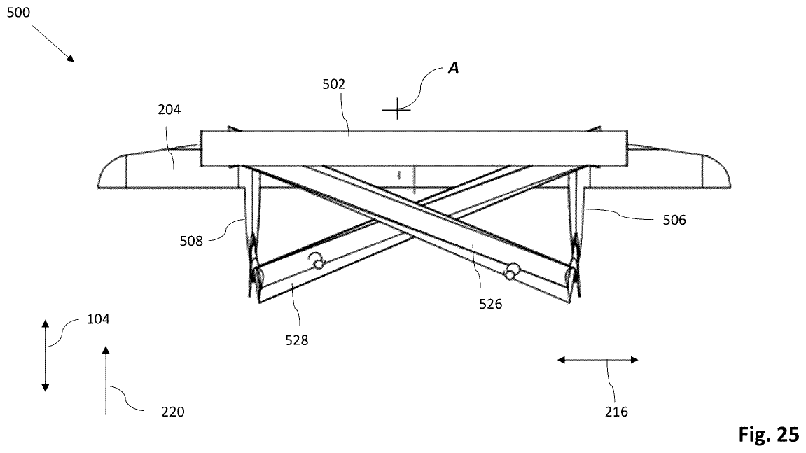

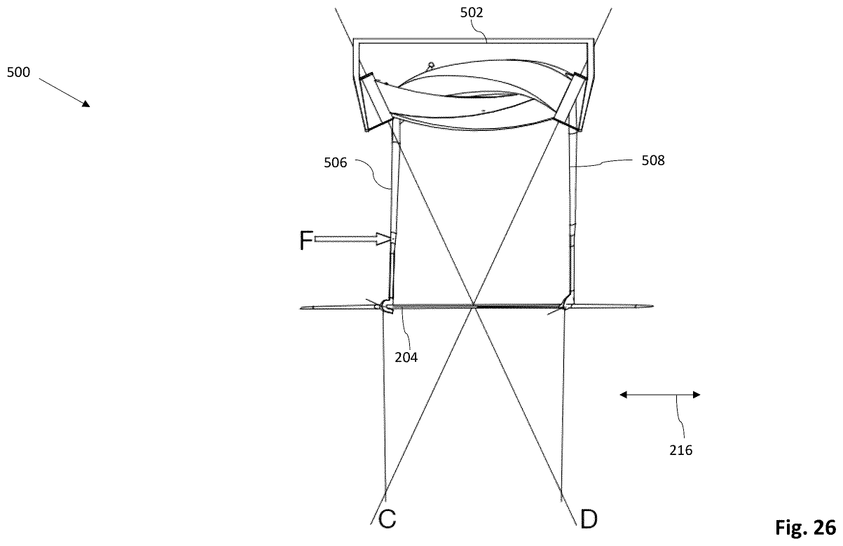

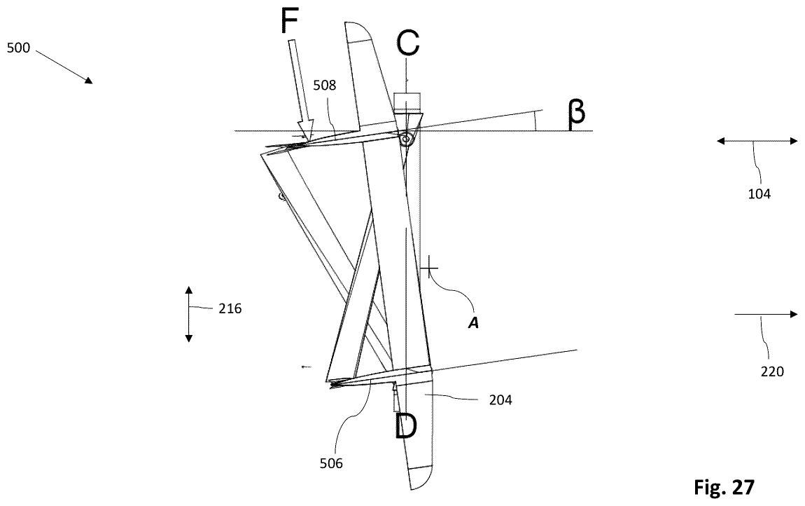

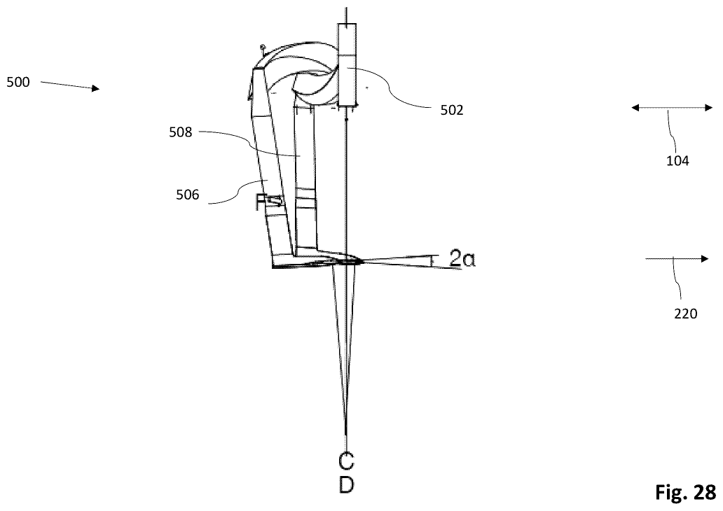

With reference to FIGS. 1 to 5, an embodiment of the hydrofoil watercraft 100 according to the second aspect of the invention is schematically illustrated. The hydrofoil watercraft 100 has a longitudinal extension 102 extending in a longitudinal direction 104. The hydrofoil watercraft 100 includes a body 106 and one or more hydrofoil arrangements 200; 300; 400; 500 according to any one of the embodiments disclosed above or below. In the embodiment of FIGS. 1 to 5, the hydrofoil watercraft 100 more specifically includes one hydrofoil arrangement 200; 300; 400; 500 according to any one of the embodiments disclosed above or below. For some embodiments, it may be defined that the body 106 of the hydrofoil watercraft 100 comprises a hull 108. For some embodiments, it may be described that one or more of the hydrofoil arrangement 200; 300; 400; 500 and base unit 202, 402, 403, 502 (see FIGS. 6 to 28) of the hydrofoil arrangement 200; 300; 400; 500, i.e. the hydrofoil arrangement 200; 300; 400; 500 and/or the base unit 202, 402, 403, 502, is/are attached to the body 106 of the hydrofoil watercraft 100. For some embodiments, the hydrofoil watercraft 100 may be described as a hydrofoil watercraft having one or more fully submerged hydrofoils or lifting wings 204, 304, i.e. one or more hydrofoils or lifting wings 204, 304 fully submerged below the surface 110 of the water 112 (see FIGS. 2 and 4). For some embodiments, the hydrofoil watercraft 100 may be described to have a transverse extensions 114 extending in a transverse direction 216 transverse to the longitudinal direction 104. For some embodiments, the watercraft 100 may be described as a water vessel, such as a boat or ship.

In general, fully submerged hydrofoils are efficient for supporting a high-speed hydrofoil watercraft in terms of low drag and a smooth ride. A drawback of conventional fully submerged lifting hydrofoils is that hydrofoil watercraft supported by such hydrofoils are unstable around the roll axis, since the centre of gravity of the hydrofoil watercraft lies above the water surface while hydrodynamic forces will act below the water surface. As mentioned above, the roll axis may be substantially parallel to the longitudinal direction 104.

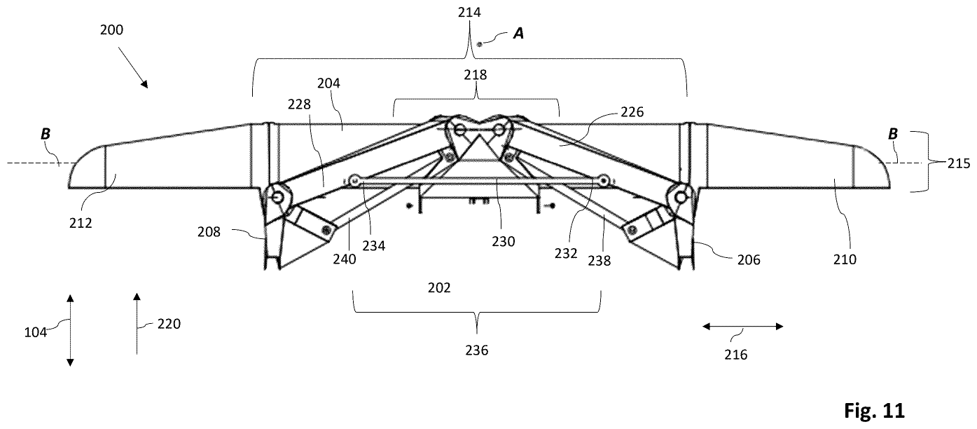

With reference to FIGS. 6 to 14, a first embodiment of the hydrofoil arrangement 200 for a hydrofoil watercraft 100 according to the first aspect of the invention is schematically illustrated. The hydrofoil arrangement 200 includes one or more base units 202 (or bases, or support units) attachable to the body 106 of the hydrofoil watercraft 100, the hydrofoil watercraft 100 having a longitudinal extension 102 extending in a longitudinal direction 104. In the embodiment of FIGS. 6 to 14, the hydrofoil arrangement 200 includes one base unit 202. However, for other embodiments, the hydrofoil arrangement 200 may include two or more base units 202. The hydrofoil arrangement 200 includes a lifting wing 204, or lift wing, and a first strut 206 attached to the lifting wing 204. The hydrofoil arrangement 200 includes a second strut 208 attached to the lifting wing 204. The first strut 206 is pivotally attached to the base unit 202 and is rotatable in relation to the base unit 202. The second strut 208 is pivotally attached to the base unit 202 and is rotatable in relation to the base unit 202. The lifting wing 204 has a first end portion 210 and a second end portion 212. The lifting wing 204 has a longitudinal extension 214 extending from the first end portion 210 to the second end portion 212. With reference to FIG. 11, for some embodiments, the lifting wing 204 may be described to have a transverse extension 215 extending in a direction transverse to the longitudinal extension 214. In general, the length of the longitudinal extension 214 of the lifting wing 204 exceeds the length of the transverse extension 215 of the lifting wing 204, for example by at least 2 to 4 times.

For some embodiments, the first strut 206 may be referred to as a starboard strut 206 configured to be located at a starboard side 118 of the hydrofoil watercraft 100, for example in relation to the second strut 208. For some embodiments, the second strut 208 may be referred to as a port strut 208 configured to be located at a port side 116 of the hydrofoil watercraft 100, for example in relation to the first strut 206.

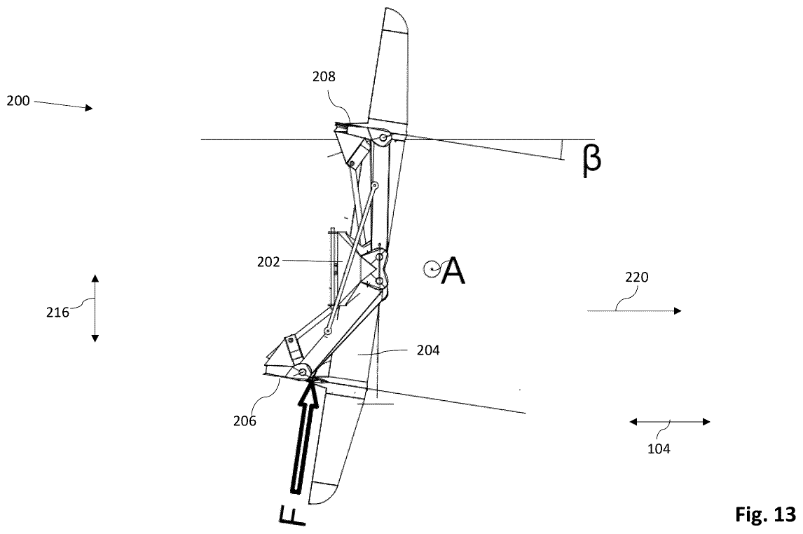

With reference to FIGS. 1 to 14, the first and second struts 206, 208 are configured to attach the lifting wing 204 to the base unit 202 such that the longitudinal extension 214 of the lifting wing 204 extends in the direction 216 of a transverse axis B transverse to the longitudinal direction 104, for example when the base unit 202 is attached to the body 106 of the hydrofoil watercraft 100. The first and second struts 206, 208 and the lifting wing 204 are rotatable, for example rotatable together, about a first pivot axis A in relation to the base unit 202, wherein the first pivot axis A is transverse to the transverse axis B and to the longitudinal direction 104. The first and second struts 206, 208 are configured to rotate about the transverse axis B in relation to the base unit 202 while the first and second struts and the lifting wing rotate, for example rotate together, about the first pivot axis A in relation to the base unit 202, for example by an angle β (see FIG. 13) about the first pivot axis A. For some embodiments, it may be defined that the first and second struts 206, 208 are configured to rotate about the transverse axis B in relation to the base unit 202 and in relation to at least a portion 218 of the lifting wing 204 (see FIG. 11), such as a middle portion 218 of the lifting wing 204, while the first and second struts 206, 208 and the lifting wing 204 rotate about the first pivot axis A in relation to the base unit 202. It is to be understood that the middle portion 218 of the lifting wing 204 is located between the first end portion 210 of the lifting wing 204 and the second end portion 212 of the lifting wing 204.

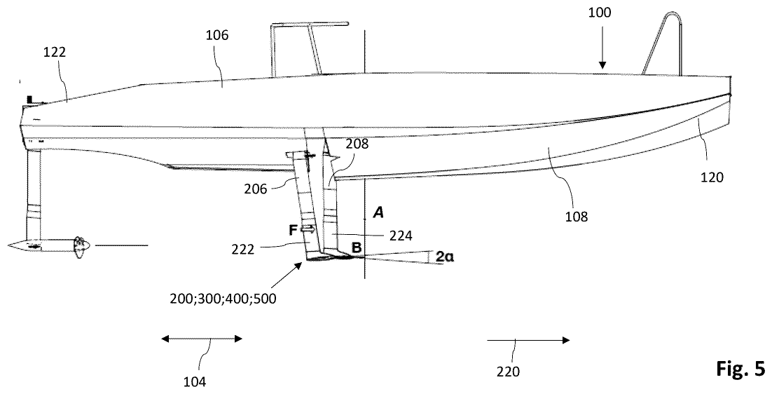

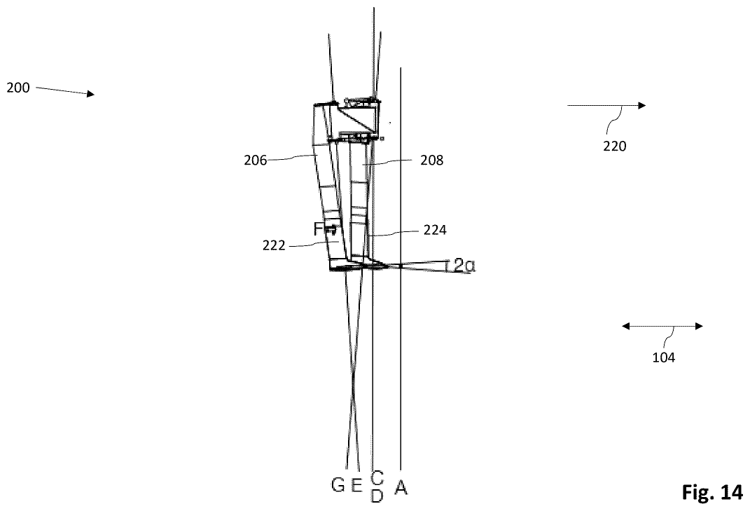

With reference to FIGS. 5 and 14, for some embodiments, the first and second struts 206, 208 are configured to rotate about the transverse axis B in relation to the base unit 202 in opposite directions, which in FIGS. 5 and 14 is illustrated by the difference in angle by 2α, i.e., as illustrated in FIGS. 5 and 14, the first strut 206 has rotated about the transverse axis B by an angle a in a first direction while the second strut 208 has rotated about the transverse axis B by an angle α in a second direction opposite the first direction. However, it is to be understood that the first strut 206 may rotate about the transverse axis B by an angle in the first direction, which is smaller or bigger than the angle by which the second strut 208 rotates about the transverse axis B in the second direction.

With reference to FIGS. 4, 5 and 12 to 14, for some embodiments it may be defined that when the first and second struts 206, 208 are subjected to a lateral hydrodynamic force F in the direction 216 of the transverse axis B, the first and second struts 206, 208 are configured to rotate about the transverse axis B in relation to the base unit 202 while the first and second struts 206, 208 and the lifting wing 204, for example together, rotate about the first pivot axis A in relation to the base unit 202. For some embodiments, when the first and second struts 206, 208 are subjected to a lateral hydrodynamic force Fin the direction 216 of the transverse axis B, the first and second struts 206, 208 may be configured to rotate about the transverse axis B in relation to the base unit 202 in opposite directions. Some conventional hydrofoil watercraft are unstable in roll. In general, the reason for this instability is that the centre of gravity of the conventional hydrofoil watercraft is above the centre of effort of the struts for hydrodynamic forces. Thus, when a conventional hydrofoil watercraft is subjected to lateral hydrodynamic forces Fin the direction 216 of a transverse axis B, the instability of the conventional hydrofoil watercraft in roll is enhanced. However, when embodiments of the hydrofoil arrangement 200 according to the first aspect of the invention, more specifically the first and second struts 206, 208 of the embodiments, are subjected a lateral hydrodynamic force Fin the direction 216 of the transverse axis

B, the stability of the associated hydrofoil watercraft 100 in roll is improved in relation to conventional solutions.

With reference to FIGS. 6 to 14, for some embodiments, it may be described that when the first and second struts 206, 208 rotate about the transverse axis B in relation to the base unit 202, the longitudinal extension 214 of the lifting wing 204 is configured to twist about the transverse axis B, or the first and second struts 206, 208 are configured to twist the lifting wing 204 is about the transverse axis B. For some embodiments, the first strut 206 may be defined to be movable in a direction 216 in parallel to the transverse axis B, and the second strut 208 may be defined to be movable in a direction 216 in parallel to the transverse axis B.

With reference to FIGS. 6 to 14, for some embodiments, the first strut 206 may be fixedly, rigidly, or non-rotatably, attached to the lifting wing 204, and the second strut 208 may be fixedly, rigidly, or non-rotatably, attached to the lifting wing 204. It is to be understood that being fixedly attached implies that the first and second struts 206, 208 are non-rotatably attached to the lifting wing 204.

With reference to FIGS. 2 and 5 to 14, the hydrofoil watercraft 100 may be described to be configured to travel in a forward direction 220. For some embodiments, when the base unit 202 is attached to the body 106 of the hydrofoil watercraft 100, the first pivot axis A is positioned in front of the centre of effort 222 of the first strut 206 and in front of the centre of effort 224 of the second strut 208 in the forward direction 220.

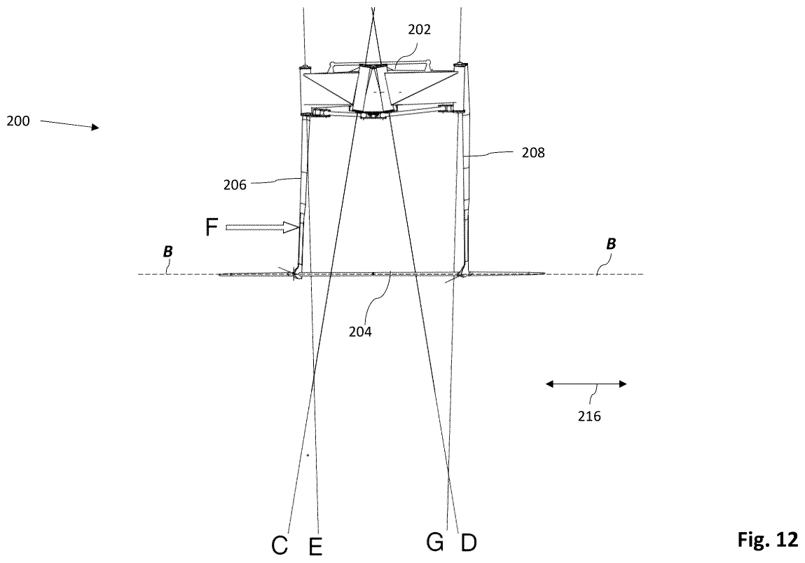

With reference to FIGS. 6 to 14, for some embodiments, the first strut 206 may be rotatable about a second pivot axis C, or an axis of rotation, in relation to the base unit 202 while the second strut 208 may be rotatable about a third pivot axis D in relation to the base unit 202. The second pivot axis C may be defined to be unparallel to the third pivot axis D. With reference to FIGS. 12, 13 and 14, for some embodiments, when subjected to a lateral hydrodynamic force Fin the direction 216 of the transverse axis B, the first and second struts 206, 208 are configured to rotate about the transverse axis B in relation to the base unit 202 while the first and second struts 206, 208 and the lifting wing 204 rotate about the first pivot axis A in relation to the base unit 202, while the first strut 206 rotates about the second pivot axis C in relation to the base unit 202, and while the second strut 208 rotates about the third pivot axis D in relation to the base unit 202.

With reference to FIGS. 6 to 14, for some embodiments, the hydrofoil arrangement 200 may include a first support arm 226 attaching the first strut 206 to the base unit 202. The hydrofoil arrangement 200 may include a second support arm 228 attaching the second strut 208 to the base unit 202. The first support arm 226 is pivotally attached to the base unit 202 and is rotatable, for example about the second pivot axis C, in relation to the base unit 202. The second support arm 228 is pivotally attached to the base unit 202 and is rotatable, for example about the third pivot axis D, in relation to the base unit 202. It may be defined that the first strut 206 is attached to the first support arm 226, and that the second strut 208 is attached to the second support arm 228. For some embodiments, it may be defined that the first support arm 226 is rotatable about the second pivot axis C in relation to the base unit 202, and that the second support arm 228 is rotatable about the third pivot axis D in relation to the base unit 202.

With reference to FIGS. 6 to 14, for some embodiments, it may be defined, when the base unit 202 is attached to the body 106 of the hydrofoil watercraft 100, the second pivot axis C crosses the third pivot axis D above one or more of the transverse axis B and longitudinal extension 214 of the lifting wing 204, i.e. above the transverse axis B and/or the longitudinal extension 214 of the lifting wing 204. For some embodiments, when the base unit 202 is attached to the body 106 of the hydrofoil watercraft 100, the second pivot axis C may even cross the third pivot axis D above the base unit 202. It is to be understood that although crossing one another, there may be a displacement between the second and third pivot axes C, D in the longitudinal direction 104.

With reference to FIGS. 6 to 14, for some embodiments, it may be defined that the second pivot axis C is transverse to the longitudinal direction 104, and that the third pivot axis D is transverse to the longitudinal direction 104. For some embodiments, it may be defined that the second pivot axis C is unparallel to the transverse axis B and to the longitudinal direction 104, and that the third pivot axis D is unparallel to the transverse axis B and to the longitudinal direction 104.

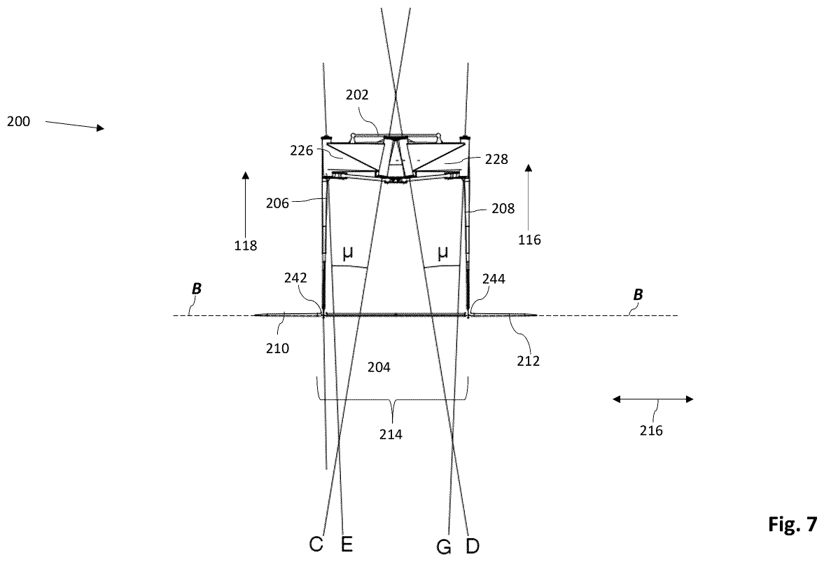

With reference to FIGS. 6 to 14, for some embodiments, the first strut 206 is rotatable about a fourth pivot axis E in relation to the base unit 202 while the second strut 208 is rotatable about a fifth pivot axis G in relation to the base unit 202. For some embodiments, when the base unit 202 is attached to the body 106 of the hydrofoil watercraft 100, the second pivot axis C crosses the fourth pivot axis E on the level of or below one or more of the transverse axis B and longitudinal extension 214 of the lifting wing 204 while the third pivot axis D crosses the fifth pivot axis G on the level of or below one or more of the transverse axis B and longitudinal extension 214 of the lifting wing 202. It is to be understood that although crossing one another, there may be a displacement between the second and fourth pivot axes C, E and a displacement between the third and fifth pivot axes D, G in the longitudinal direction 104. For some embodiments, the first strut 206 may be rotatable about the fourth pivot axis E in relation to the first support arm 226 while the second strut 208 may be rotatable about the fifth pivot axis G in relation to the second support arm 228. For some embodiments, as illustrated in FIG. 7, when viewed from the front or bow 120 of the hydrofoil watercraft 100, there is an angle μ between the second and fourth axes C, E and a corresponding angle μ between the third and fifth axes D, G.

With reference to FIGS. 4 and 6 to 14, for some embodiments, when the base unit 202 is attached to the body 106 of the hydrofoil watercraft 100, the second pivot axis C is inclined upward to a port side 116 of the hydrofoil watercraft 100 in relation to the fourth pivot axis E, the third pivot axis D is inclined upward to a starboard side 118 of the hydrofoil watercraft 100 in relation to the fifth pivot axis G, the second pivot axis C is positioned in front of the fourth pivot axis E in the forward direction 220, and the third pivot axis D is positioned in front of the fifth pivot axis G in the forward direction 220.

With reference to FIGS. 12 to 14, for some embodiments, when subjected to a lateral hydrodynamic force Fin the direction 216 of the transverse axis B, the first and second struts 206, 208 are configured to rotate about the transverse axis B in relation to the base unit 202 while the first and second struts 206, 208 and the lifting wing 204 rotate about the first pivot axis A in relation to the base unit 202, while the first strut 206 rotates about the second and fourth pivot axes C, E in relation to the base unit 202, and while the second strut 208 rotates about the third and fifth pivot axes D, G in relation to the base unit 202.

With reference to FIGS. 4, 7 and 8, for some embodiments, when the base unit 202 is attached to the body 106 of the hydrofoil watercraft 100, the second pivot axis C is inclined upward to a port side 116 of the hydrofoil watercraft 100 in relation to the fourth pivot axis E, the third pivot axis D is inclined upward to a starboard side 118 of the hydrofoil watercraft 100 in relation to the fifth pivot axis G, the second pivot axis C is positioned in front of the fourth pivot axis E in the forward direction 220, and the third pivot axis D is positioned in front of the fifth pivot axis G in the forward direction 220.

With reference to FIGS. 9 and 11, the hydrofoil arrangement 200 may include one or more first links 230 pivotally connecting the first support arm 226 to the second support arm 228, for example one first link 230 as in the embodiment illustrated in FIGS. 6 to 14. However, for other embodiments, the hydrofoil arrangement 200 may include two or more first links 230. The one or more first links 230 may include a first end portion 232 and a second end portion 234. The one or more first links 230 may have a longitudinal extension 236 extending from the first end portion 232 to the second end portion 234 of the one or more first links 230. For some embodiments, the one or more first links 230 may be adjustable so as to adjust the length of the longitudinal extension 236 of the one or more first links 230 so as to control or adjust the angle of incidence of the lifting wing 204 by way of the adjustability of the one or more first links 230. The one or more first links 230 may assists in keeping the first and second struts 206, 208 parallel to one another adjacent to the base unit 202. The first link 230 may comprise or consist of a bar, a rod, or a wire, or any other member.

With reference to FIGS. 9 and 11, the hydrofoil arrangement 200 may include one or more second links 238 pivotally connecting the first strut 206 to the base unit 202, for example one second link 238 as in the embodiment illustrated in FIGS. 6 to 14.

However, for other embodiments, the hydrofoil arrangement 200 may include two or more second links 238. The hydrofoil arrangement 200 may include one or more third links 240 pivotally connecting the second strut 208 to the base unit 202, for example one third link 240 as in the embodiment illustrated in FIGS. 6 to 14. However, for other embodiments, the hydrofoil arrangement 200 may include two or more third links 240. The second and third links 238, 240 may assist in controlling any twisting of the first and second struts 206, 208. The second link 238 or the third link 240 may comprise or consist of a bar, a rod, or a wire, or any other member.

For alternative embodiments, the hydrofoil arrangement 200 may comprise one or more fourth links pivotally connecting the first strut 206 to the second strut 208, for example adjacent to the base unit 202, such as at top sections of the first and second struts 206, 208 when the base unit 202 is attached to the body 106 of the hydrofoil watercraft 100. The one or more fourth links may assist in keeping the first and second struts 206, 208 parallel to one another adjacent to the base unit 202. The fourth link may comprise or consist of a bar, a rod, or a wire, or any other member.

With reference to FIG. 7, for some embodiments, the transverse axis B may extend through the first and second end portions 210, 212 of the lifting wing 204. For some embodiments, the transverse axis B may extend from the attachment 242 of the first strut 206 to the lifting wing 204 to the attachment 244 of the second strut 208 to the lifting wing 204. For some embodiments, the transverse axis B may extend through the longitudinal extension 214 of the lifting wing 204.

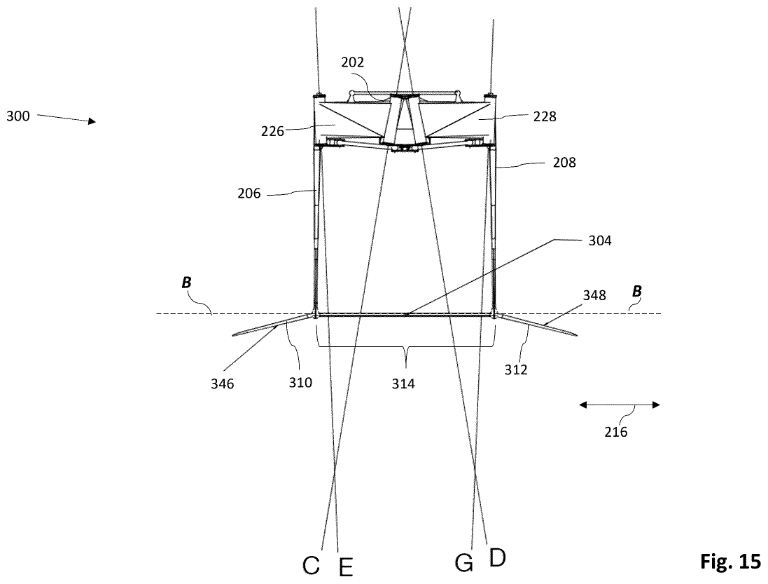

With reference to FIG. 15, a second embodiment of the hydrofoil arrangement 300 for a hydrofoil watercraft 100 according to the first aspect of the invention is schematically illustrated. Several features of the embodiment of the hydrofoil arrangement 300 of FIG. 15 may correspond to features of the embodiment of the hydrofoil arrangement 200 of FIGS. 6 to 14 and are thus not repeated here to avoid repetition. In addition to the features which the second of embodiment of the hydrofoil arrangement 300 in FIG. 15 has in common with the first embodiment of the hydrofoil arrangement 200 in FIGS. 6 to 14, the first end portion 310 of the lifting wing 304 includes a first end 346 while the second end portion 312 of the lifting wing 304 includes a second end 348. When the base unit 202 of the hydrofoil arrangement 300 of FIG. 15 is attached to the body 106 of the hydrofoil watercraft 100, the first end 346 is angled downward in relation to one or more of the transverse axis Band longitudinal extension 314 of the lifting wing 304 while the second end 348 is angled downward in relation to one or more of the transverse axis B and longitudinal extension 314 of the lifting wing 304, i.e. in relation to the transverse axis B and/or the longitudinal extension 314. Otherwise, the hydrofoil arrangement 300 in FIG. 15 may correspond to the hydrofoil arrangement 200 in FIGS. 6 to 14. The angle between the first end 346 and the longitudinal extension 314 of the lifting wing 304, or the angle between the second end 348 and the longitudinal extension 314 of the lifting wing 304, may be referred to as an anhedral. The angle or anhedral may be in the range of 5 to 30 degrees. However, other ranges are also possible. An advantage of the anhedral is that the first and second ends 346, 348 can be kept lower under the surface of the water without any extension of the first and second struts 206, 208 in length, thus allowing a higher banking-angle in a turn while keeping the first and second ends 346, 348 below the surface of the water. Another advantage of the anhedral is that the outer parts of the lifting wing 304 get a longer leverage for applying roll-moment around the centre of gravity of the watercraft 100, providing an even more efficient roll-stabilisation.

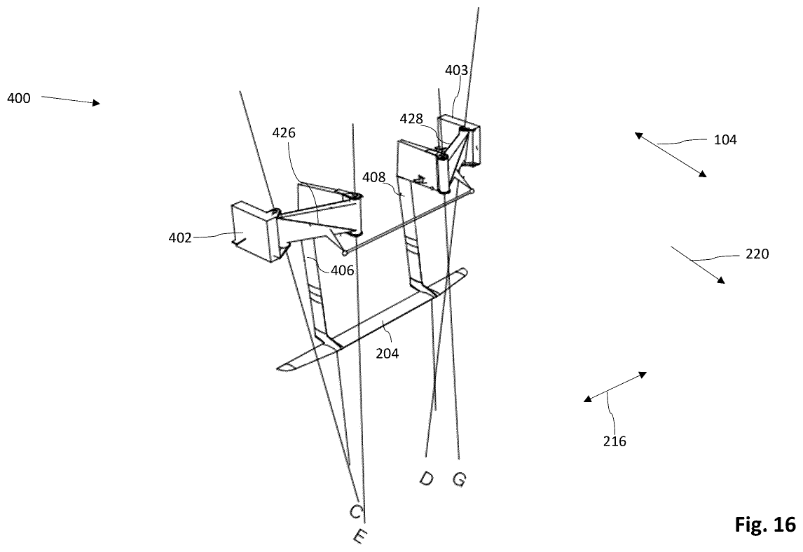

With reference to FIGS. 16 to 21, a third embodiment of the hydrofoil arrangement 400 for a hydrofoil watercraft 100 according to the first aspect of the invention is schematically illustrated. Several features of the embodiment of the hydrofoil arrangement 400 of FIGS. 16 to 21 may correspond to features of the embodiment of the hydrofoil arrangement 200 of FIGS. 6 to 14 and are thus not repeated here to avoid repetition. In addition to the features which the third of embodiment of the hydrofoil arrangement 400 in FIGS. 16 to 21 has in common with the first embodiment of the hydrofoil arrangement 200 in FIGS. 6 to 14, the hydrofoil arrangement 400 of FIGS. 16 to 21 includes two or more base units 402, 403, more specifically two base units 402, 403 in the embodiment illustrated in FIGS. 16 to 21. However, for alternative embodiments, the hydrofoil arrangement may include three or more base units. The first strut 406 may be pivotally attached to one 402 of the base units 402, 403 and rotatable in relation to said one 402 of the base units 402, 403, for example about the second and fourth pivot axes C, E, while the second strut 408 may be pivotally attached to the other one 403 of the base units 402, 403 and rotatable in relation to said other one 402 of the base units 402, 403, for example about the third and fifth pivot axes D, G.

With reference to FIGS. 16 to 21, as for the previous embodiments, the hydrofoil arrangement 400 may include a first support arm 426 and a second support arm 428. The first support arm 426 may attach the first strut 406 to one 402 of the base units 402, 403 while the second support arm 428 may attach the second strut 408 to the other one 403 of the base units 402, 403.

With reference to FIGS. 4, 17 and 18, when the base unit 402, 403 is attached to the body 106 of the hydrofoil watercraft 100, the second pivot axis Cis inclined upward to a starboard side 118 of the hydrofoil watercraft 100 in relation to the fourth pivot axis E, the third pivot axis D is inclined upward to a port side 116 of the hydrofoil watercraft 100 in relation to the fifth pivot axis G, the second pivot axis C is positioned behind the fourth pivot axis E in the forward direction 220, and the third pivot axis D is positioned behind the fifth pivot axis G in the forward direction 220. An advantage of placing the first and second support arms and base units outside of the struts, as in the third embodiment, is that it allows more useful space for a centre aisle in a passenger hydrofoil craft.

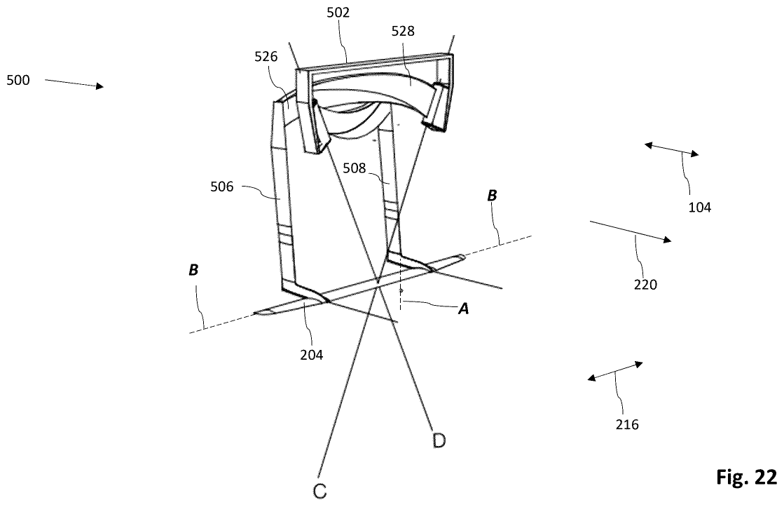

With reference to FIGS. 22 to 28, a fourth embodiment of the hydrofoil arrangement 500 for a hydrofoil watercraft 100 according to the first aspect of the invention is schematically illustrated. Several features of the embodiment of the hydrofoil arrangement 500 of FIGS. 22 to 28 may correspond to features of the embodiment of the hydrofoil arrangement 200 of FIGS. 6 to 14 and are thus not repeated here to avoid repetition. In addition to the features which the fourth of embodiment of the hydrofoil arrangement 500 in FIGS. 22 to 28 has in common with the first embodiment of the hydrofoil arrangement 200 in FIGS. 6 to 14, the hydrofoil arrangement 500 includes the features that when the base unit 502 is attached to the body 106 of the hydrofoil watercraft 100, the second pivot axis C crosses the third pivot axis D on the level of or below one or more of the transverse axis B and longitudinal extension 214 of the lifting wing 204. It is to be understood that although crossing one another, there may, or may not, be a displacement between the second and third pivot axes C, D in the longitudinal direction 104.

As for the first embodiment of FIGS. 6 to 14, the hydrofoil arrangement 500 of FIGS. 22 to 28 may, for some embodiments, include a first support arm 526 attaching the first strut 506 to the base unit 502, and the hydrofoil arrangement 500 may include a second support arm 528 attaching the second strut 508 to the base unit 502. The first support arm 526 is pivotally attached to the base unit 502 and is rotatable, for example about the second pivot axis C, in relation to the base unit 502. The second support arm 528 is pivotally attached to the base unit 502 and is rotatable, for example about the third pivot axis D, in relation to the base unit 502.

With reference to FIGS. 22 to 28, for some embodiments, when the base unit 202 is attached to the body 106 of the hydrofoil watercraft 100, the second and third pivot axes C, D are positioned in front of the centre of effort 222 of the first strut 206 and in front of the centre of effort 224 of the second strut 208 in the forward direction 220. The hydrofoil arrangement 500 of FIGS. 22 to 28 may has the advantage that just a single pivot axis C, D is required for each one of the first and second struts 506, 508. Thus, the fourth pivot axis E and the fifth pivot axis G of embodiments disclosed are not present in the hydrofoil arrangement 500 of FIGS. 22 to 28.

With reference to FIGS. 1 to 28, for some embodiments, it may be defined that the hydrofoil watercraft 100 has a bow 120 (front end) and a stern 122 (rear end). For some embodiments, the first pivot axis A may be positioned between the bow 120 of the hydrofoil watercraft 100 and an imaginary straight line intersecting the centre of effort 222 of the first strut 206 and the centre of effort 224 of the second strut 208. For some embodiments, it may be defined that the hydrofoil watercraft 100 is configured to travel in the forward direction 220 extending from the stern 122 toward the bow 120 of the hydrofoil watercraft 100.

For some embodiments, the combined rotation about the second and fourth pivot axis C, E and about the third and fifth pivot axis D, G may be described to have a resultant, such as a vertical resultant, for the lifting wing 204 and the first and second struts 206, 208 at the position of the first pivot axis A. This combined rotation about the second and fourth pivot axis C, E and about the third and fifth pivot axis D, G may also be described to have a horizontal resultant about the transverse axis in one direction for the first strut and a first outer portion of the wing and in the opposite direction for the second strut and a second outer portion of the wing. It is to be understood that each one of the pivot axes A, C, D, E and G may be referred to as an imaginary pivot axis. One or more of the second to fifth pivot axes C, D, E and G may be provided by and/or extend through a shaft, a bearing, a hinge, or any other pivoting unit or configuration. Any one of the pivotal attachments or connections mentioned above may be provided or attained by a shaft, a bearing, a hinge, a guide, or any other pivoting unit or configuration. The hydrofoil arrangement 200; 300; 400; 500 may include conventional means or members of attachment for attaching the base unit 202, 402, 403, 502 to the body 106 of the hydrofoil watercraft 100, such as bolts or screws, or any other means of attachment. When the base unit 202, 402, 403, 502 is attached to the body 106 of the hydrofoil watercraft 100, the first pivot axis A may extend substantially vertically, at least in calm water. When the base unit 202, 402, 403, 502 is attached to the body 106 of the hydrofoil watercraft 100, the transverse axis B may extend in a substantially horizontal direction, at least in calm water.

For some embodiments, one or more of the base unit 202, 402, 403, 502, lifting wing 204, 304, first strut 206, 406, 506 second strut 208, 408, 508 first support arm 226, 426, 526, second support arm 228, 428, 528, first link 230, second link 238, third link 240 and fourth link may be made of a material comprising or consisting of a polymer or a polymer composite, such as plastic, a fibre-reinforced polymer (FRP), or any other polymer or polymer composite. For some embodiments, one or more of the base unit, lifting wing, first strut, second strut, first support arm, second support arm, first link, second link, third link and fourth link may be made of a material comprising or consisting of a metal or a metal alloy, such as aluminium, or any other metal or metal alloy. However, it is to be understood that other materials are possible. For example, for some embodiments, mixtures of one or more polymers and one or more metals are possible.

It is to be understood that embodiments of the hydrofoil arrangement 200; 300; 400; 500 may be applied to a hydrofoil watercraft different from the hydrofoil watercraft 100 illustrated in FIGS. 1 to 5, for example to a windsurfing board, or a canoe, having one or more lifting wings, or any other water vessel having one or more lifting wings.

The present invention is not limited to the above-described embodiments. Instead, the present invention relates to, and encompasses all different embodiments being included within the scope of the independent claim.

1. A hydrofoil arrangement for a hydrofoil watercraft, wherein the hydrofoil arrangement comprises
one or more base units attachable to a body of the hydrofoil watercraft having a longitudinal extension extending in a longitudinal direction,
a lifting wing,
a first strut attached to the lifting wing, and
a second strut attached to the lifting wing,
wherein the first strut is pivotally attached to the base unit and is rotatable in relation to the base unit,
wherein the second strut is pivotally attached to the base unit and is rotatable in relation to the base unit,
wherein the lifting wing comprises a first end portion and a second end portion,
wherein the lifting wing has a longitudinal extension extending from the first end portion to the second end portion,
wherein the first and second struts are configured to attach the lifting wing to the base unit such that the longitudinal extension of the lifting wing extends in the direction of a transverse axis transverse to the longitudinal direction,
wherein the first and second struts and the lifting wing are rotatable about a first pivot axis in relation to the base unit, the first pivot axis being transverse to the transverse axis and the longitudinal direction, and
wherein the first and second struts are configured to rotate about the transverse axis in relation to the base unit while the first and second struts and the lifting wing rotate about the first pivot axis in relation to the base unit.

2. The hydrofoil arrangement according to claim 1, wherein when subjected to a lateral hydrodynamic force in the direction of the transverse axis, the first and second struts are configured to rotate about the transverse axis in relation to the base unit while the first and second struts and the lifting wing rotate about the first pivot axis in relation to the base unit.

3. The hydrofoil arrangement according to claim 1, wherein the first and second struts are configured to rotate about the transverse axis in relation to the base unit in opposite directions.

4. The hydrofoil arrangement according to claim 1, wherein when the first and second struts rotate about the transverse axis in relation to the base unit, the longitudinal extension of the lifting wing is configured to twist about the transverse axis.

5. The hydrofoil arrangement according to claim 1, wherein the first strut is movable in a direction in parallel to the transverse axis, and
wherein the second strut is movable in a direction in parallel to the transverse axis.

6. The hydrofoil arrangement according to claim, 1, wherein the first strut is fixedly attached to the lifting wing, and
wherein the second strut is fixedly attached to the lifting wing.

7. The hydrofoil arrangement according to claim 1, wherein the hydrofoil watercraft is configured to travel in a forward direction, and
wherein when the base unit is attached to the body of the hydrofoil watercraft the first pivot axis is positioned in front of the centre of effort of the first strut and in front of the centre of effort of the second strut in the forward direction.

8. The hydrofoil arrangement according to claim 1, wherein the first strut is rotatable about a second pivot axis in relation to the base unit, and
wherein the second strut is rotatable about a third pivot axis in relation to the base unit.

9. The hydrofoil arrangement according to claim 8, wherein the second pivot axis is unparallel to the third pivot axis.

10. The hydrofoil arrangement according to claim 8, wherein when subjected to a lateral hydrodynamic force in the direction of the transverse axis, the first and second struts are configured to rotate about the transverse axis in relation to the base unit while the first and second struts and the lifting wing rotate about the first pivot axis in relation to the base unit, while the first strut rotates about the second pivot axis in relation to the base unit, and while the second strut rotates about the third pivot axis in relation to the base unit.

11. The hydrofoil arrangement according to claim 8, wherein the hydrofoil watercraft is configured to travel in a forward direction, and
wherein when the base unit is attached to the body of the hydrofoil watercraft the second and third pivot axes are positioned in front of the centre of effort of the first strut and in front of the centre of effort of the second strut in the forward direction.

12. The hydrofoil arrangement according to claim 1, wherein the hydrofoil arrangement comprises a first support arm attaching the first strut to the base unit,
wherein the hydrofoil arrangement comprises a second support arm attaching the second strut to the base unit,
wherein the first support arm is pivotally attached to the base unit and is rotatable in relation to the base unit, and
wherein the second support arm is pivotally attached to the base unit and is rotatable in relation to the base unit.

13. The hydrofoil arrangement according to claim 8, wherein when the base unit is attached to the body of the hydrofoil watercraft the second pivot axis crosses the third pivot axis on the level of or below one or more of the transverse axis and longitudinal extension of the lifting wing.

14. The hydrofoil arrangement according to claim 8, wherein when the base unit is attached to the body of the hydrofoil watercraft the second pivot axis crosses the third pivot axis above one or more of the transverse axis and longitudinal extension of the lifting wing.

15. The hydrofoil arrangement according to claim 8, wherein when the base unit is attached to the body of the hydrofoil watercraft the second pivot axis crosses the third pivot axis above the base unit.

16. The hydrofoil arrangement according to claim 8, wherein the second pivot axis is transverse to the transverse axis and the longitudinal direction, and
wherein the third pivot axis is transverse to the transverse axis and the longitudinal direction.

17. The hydrofoil arrangement according to claim 8, wherein the second pivot axis is unparallel to the transverse axis and the longitudinal direction, and
wherein the third pivot axis is unparallel to the transverse axis and the longitudinal direction.

18. The hydrofoil arrangement according to claim 8, wherein the first strut is rotatable about a fourth pivot axis in relation to the base unit, and
wherein the second strut is rotatable about a fifth pivot axis in relation to the base unit.

19. The hydrofoil arrangement according to claim 18, wherein when the base unit is attached to the body of the hydrofoil watercraft the second pivot axis crosses the fourth pivot axis on the level of or below one or more of the transverse axis and longitudinal extension of the lifting wing while the third pivot axis crosses the fifth pivot axis on the level of or below one or more of the transverse axis and longitudinal extension of the lifting wing.

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. The hydrofoil watercraft having a longitudinal extension extending in a longitudinal direction, wherein the hydrofoil watercraft comprises a body and one or more hydrofoil arrangements according to claim 1.
